(19) United States
(12) Patent Application Publication
(10) Pub. No.: US 2026/0018184 A1
(43) Pub. Date: Jan. 15, 2026

(54) ACTIVE SOUND MANAGEMENT SYSTEM IN A WORK MACHINE

(71) Applicant: Deere & Company, Moline, IL (US)

(72) Inventors: Giovanni A. WUISAN, Epworth, IA (US); Scott J. BREINER, Dubuque, IA (US); Kyle A. HOLL, Durango, IA (US); Christopher B. HOWARD, Dubuque, IA (US)

(21) Appl. No.: 18/770,309

(22) Filed: Jul. 11, 2024

(51) Int. Cl. G10L 21/0364; G10L 21/0216; G10L 21/034; G10L 25/51; H04R 1/32

(52) U.S. Cl. CPC G10L 21/0364; G10L 21/0216; G10L 21/034; G10L 25/51; H04R 1/326; G10L 2021/02163

(57) ABSTRACT

A sound management system in a work machine detects sound and identifies a component of the sound, such as machine noise or other components. The sound management system generates a control signal to perform sound management based upon the identified sound component. The control signal can selectively reduce or cancel noise components, selectively amplify sound components, insert sound components, or perform other sound management operations.

### FIELD OF THE DESCRIPTION

The present description relates to work machines. More specifically, the present description relates to active sound management in a work machine.

### BACKGROUND

There are many different types of work machines, including construction machines, agricultural machines, forestry machines, turf management machines, among others. Operators of such machines are often exposed to a high sound level environment. Therefore, some current systems attempt to manage the sound environment to improve operator comfort.

Some current attempts to manage the sound environment have focused on overall operator compartment noise reduction through isolation, insulation, and other such techniques. Operator compartment isolation attenuates all environmental sounds that originate outside the operator compartment. Other attempts to manage the sound environment include wearing personal protective equipment, such as ear protection, that again attenuates all sound.

The discussion above is merely provided for general background information and is not intended to be used as an aid in determining the scope of the claimed subject matter.

### SUMMARY

A sound management system in a work machine detects sound and identifies a component of the sound, such as machine noise or other components. The sound management system generates a control signal to perform sound management based upon the identified sound component. The control signal can selectively reduce or cancel noise components, selectively amplify sound components, insert sound components, or perform other sound management operations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1A and 1B (collectively referred to herein as FIG. 1) is a block diagram of one example of a work machine having a sound management system.

FIG. 2 is a flow diagram illustrating one example of the operation of the work machine illustrated in FIG. 1.

FIG. 3 shows one example of a sound management system deployed fully or partially in a remote server environment.

FIGS. 4, 5, and 6 show examples of mobile devices that can be used in a work machine.

FIG. 7 is a block diagram showing one example of a computing environment that can be used in the machines or systems shown in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, it is not uncommon for work machines to be high volume environments for the operators that operate those work machines. Therefore, the operators frequently wear noise management personal protective equipment to reduce or attenuate all noise or sound generated in the environment. Some attempts have also been made to manage the sound environment by insolating the operator from all noise in the environment through insulating the operator compartment. Again, both of these attempts to manage sound attenuate all sound generated in the environment. However, this presents some difficulties.

For instance, it is not uncommon for an operator to notice a change in the sound generated by a work machine, where the change in sound signifies to the operator that a problem is occurring or is about to occur. As an example, the operator may hear a noise that the operator recognizes as a bearing that has gone out or is about to need maintenance. Similarly, the operator may notice a noise indicating that a track or other ground-engaging element needs maintenance, that a part of the engine needs maintenance, or that the work machine is colliding with another object or machine. In addition, it is not uncommon for the operator of a work machine to be working with another human being who is outside the operator compartment, such as a worker who is working on the ground being engaged by the work machine. In such a scenario, it may be desirable for the operator to be able to hear the other worker or to otherwise communicate with the other worker.

The present description thus describes an active sound management system which uses devices, earpieces, headphones, or other speakers that provide sound to an operator in an operator compartment of a work machine. The active sound management system identifies components of sound generated in the environment and then manages those sounds based upon management criteria. For instance, in one example, the management criteria indicate that machine sounds should be cancelled or reduced while other sounds (such as human voices or other sounds) 11 should be passed to the operator or amplified. In such a scenario, a component processing system cancels or suppresses machine sounds while allowing other sounds to be transmitted to the operator through the speakers, earpieces, and/or headphones.

In other examples, other sound components may be identified and processed (e.g., cancelled, suppressed, amplified, etc.). For instance, if a machine sound corresponds to a flagged item (such as a maintenance item, a failing part, a trouble code, etc.), then an alarm or other alert message may be injected into the sound passed to the operator.

Further, in one example, the sound management criteria may be operator configurable through a user experience that allows the operator to set the criteria for sound management. The operator configurable criteria may then be stored and indexed by operator so they can be retrieved and downloaded when the same operator is operating the work machine at a subsequent time.

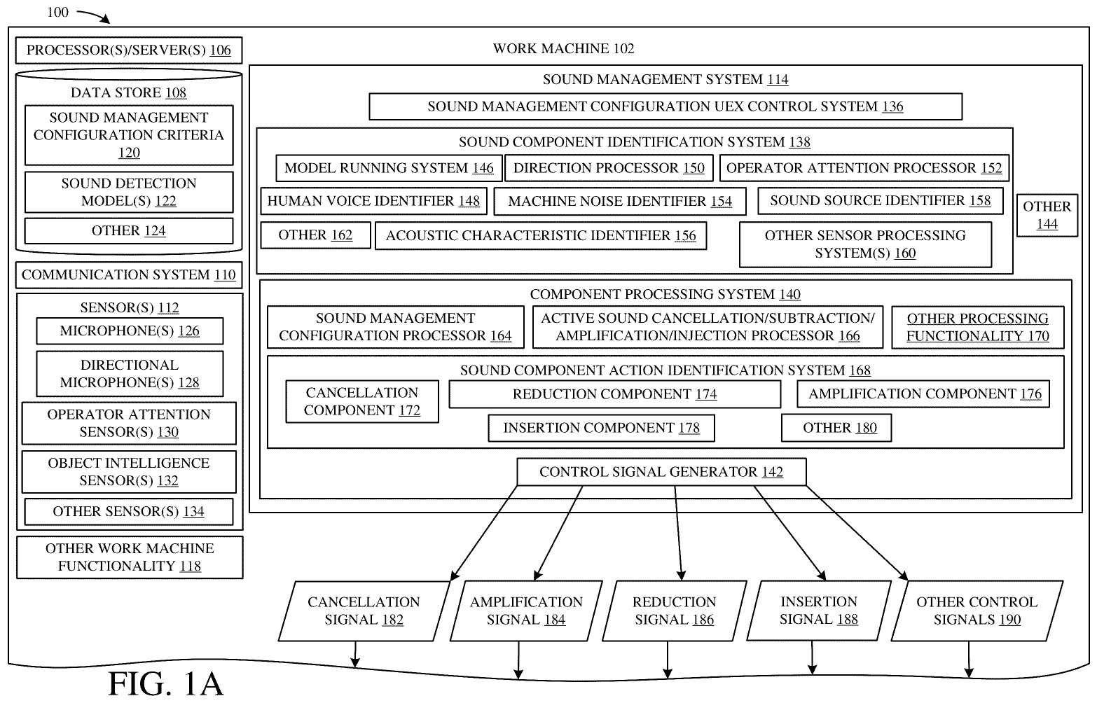

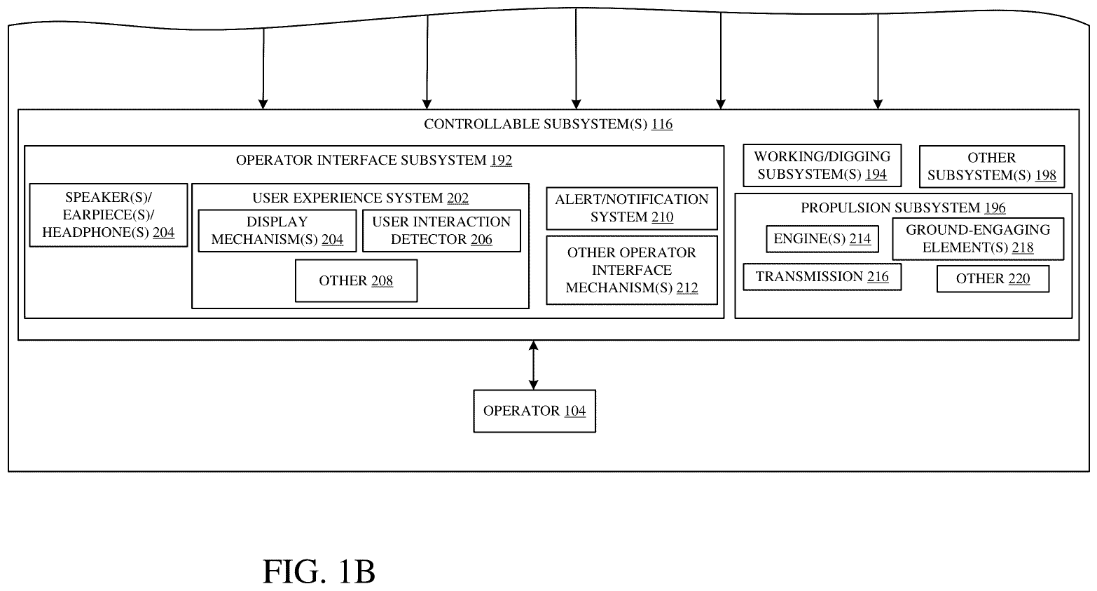

FIG. 1 is a block diagram of one example of a work machine system 100 in which a work machine 102 is operated by an operator 104. Work machine 102 may be a construction machine (such as an excavator, a loader, a truck, etc.), a forestry machine (such as a knuckle boom loader, a truck, etc.), an agricultural machine, a turf management machine, or any of a wide variety of other work machines. In the example shown in FIG. 1, work machine 102 includes one or more processors or servers 106, data store 108, communication system 110, one or more sensors 112, sound management system 114, controllable subsystems 116, and other work machine functionality 118. Also, in the example shown in FIG. 1, data store 108 can include sound management configuration criteria 120, one or more sound detection models 122, and other items 124. Sensors 112 can include microphones 126, directional microphones 128, one or more operator attention sensors 130, one or more object intelligence 132, and any of a wide variety of other sensors 134. Sound management system 114 can include sound management configuration user experience (UEX) control system 136, sound component identification system 138, component processing system 140, control signal generator 142, and other items 144. Sound component identification system 138 can include model running system 146, human voice identifier 148, direction processor 150, operator attention processor 152, machine noise identifier 154, acoustic characteristics identifier 156, sound source identifier 158, one or more other sensor processing systems 160, and other items 162. Component processing system 140 can include sound management configuration processor 164, active sound cancellation/subtraction/amplification/injection processor 166, sound component action identification system 168, and other processing functionality 170. Sound component action identification system 168 can include cancellation component 172, reduction component 174, amplification component 176, insertion component 178, and other items 180. Component processing system 140 generates an output to control signal generator 142. Control signal generator 142 generates one or more control signals that can be provided to control one or more of the controllable subsystems 116. The control signals can include cancellation signal 182, amplification signal 184, reduction signal 186, insertion signal 188, and any of a wide variety of other control signals 190.

Controllable subsystems 116 can include operator interface system 192, working/digging subsystems 194, propulsion subsystem 196, and any of a wide variety of other systems 198. Operator interface subsystem 192 can include one or more speakers, earpieces, or headphones 200, user experience system 202 (which may include display mechanisms 204, user interaction detector 206, and other items 208), alert/notification system 210, and other operator interface mechanisms 212. Propulsion subsystem 196 can include one or more motors or engines 214, transmission 216, ground-engaging elements (such as wheels or tracks) 218 and other items 220. Before describing the overall operation of work machine 102 and sound management system 114, a description of some of the items in work machine system 100 will first be provided.

It will first be assumed that operator 104 may reside in an operator compartment of work machine 102. Thus, operator 104 may have wired or wireless speakers, earpieces, or headphones 200 that provide sound for perception by operator 104.

Operator 104 may also have access to user experience system 202 which may be a system that walks operator 104 through a user experience by which operator 104 can generate sound management configuration criteria 120. For instance, operator 104 may be provided with a display on display mechanism 204 that allows operator 104 to select which sound components the operator 104 may want to hear, which sound components the operator 104 may want cancelled, among other things. Operator 104 may, for instance, interact with the display or interface generated on display mechanism 204 by indicating that the operator wishes to only receive sound that is generated from a source other than the work machine 102, itself. In another example, operator 104 may interact with an interface to provide an indication that the operator 104 wishes to hear external noise or sound generated outside of work machine 102 in a particular direction (such as when operator 104 will be working with another human being or another machine which may be located on one side or the other of work machine 102). Operator 104 may provide an input to hear sounds from other sources (such as from certain microphones 126, directional microphones 128, object intelligence sensors 132, etc.). User interaction detector 206 detects operator interaction with the interfaces and can store the sound management configuration criteria 120 indicated by the interactions, for use by sound management system 114. It may also be that operator 104 configures the system to send an alert or notification when certain problematic sounds are generated. In that case, when sound management component 114 identifies such sounds, alert/notification system 210 can generate or provide an alert to operator 104 by inserting an alert, a pre-recorded message, etc. into the sound provided to operator 104. Sound management configuration criteria 120 may be indexed per operator, or may be default criteria, or other pre-defined criteria.

Sound detection models 122 may include mechanisms or techniques used to identify certain sounds. One such model may be a tone detector that detects one or more different tones (or frequencies). Sound detection models 122 can be simple detectors or algorithms, or models 122 may be artificial intelligence or other machine learning models that are trained to identify certain sounds. The models 122 may be trained to identify human voices, machine sounds, sounds of other machines adjacent work machine 102, or other sounds. Models 122 may also be trained to identify different types of machine sounds. For instance, models 122 may be trained to identify machine sounds that indicate problems, faults, or required maintenance, or other items. By way of example, when models 122 are machine learning models, the models 122 may be trained on sounds that are made by bearings, engines, transmissions, actuators, or other items that require maintenance, that are about to require maintenance, that are broken or about to break, etc. Models 122 may also be trained to identify sounds indicative of a collision (such as a collision of machine 102 with another work machine, with a wall or other obstacle, etc.). When models 122 are more simple detectors, the models 122 can be configured to detect one or more different frequencies, patterns, volumes, etc. Models 122 may be trained to identify any of a wide variety of other components in the sound captured or sensed in the environment of work machine 102.

Communication system 110 may facilitate the communication of items on work machine 102 with one another. Therefore, communication system 110 may be a controller area network (CAN) bus and bus controller, a communication system that communicates over a wide area network, communication over a local area network, a near field communication system, a Bluetooth or Wi-Fi communication system, a cellular communication system, or any of a variety of other communication systems or combinations of communication systems.

Microphones 126 may be deployed at different locations on work machine 102 to capture different sounds. For instance, one or more microphones may be deployed in the operator compartment of work machine 102, exterior to work machine 102, and/or adjacent certain parts of work machine 102 that may be monitored (such as in a location to pick up noise from bearings, tracks, an engine, other transmissions items, etc.). Directional microphones 128 may be mounted on work machine 102 and directed to capture sound in one or more different directions. In one example, the directional microphones 128 can be aimed by operator 104 or by an automated system. Therefore, when operator 104 is working with a human on the ground or outside of the operator compartment of work machine 102, operator 104 can aim one of the directional microphones 128 at the other human being to capture sound components (such as the human voice or other components) generated by that other human being. In another example, the other human being may be identified as set out elsewhere herein and directional microphones 128 can be automatically aimed in the direction of the human being. The directional microphones 128 can be directed in other directions to capture other sound components as well.

Operator attention sensors 130 may include image capture sensors (such as cameras) along with corresponding image processing systems that process images captured by the image capture system. The image capture devices may be aimed to capture images of operator 104 and the image processing system may process the images to identify operator attention characteristics. The operator attention characteristics may indicate a direction in which operator 104 is looking, whether operator 104 is speaking, or other characteristics of the attention of operator 104. Operator attention sensors 130 may include sensors on a steering wheel, joysticks, or other operator input mechanisms that indicate whether the operator is touching those mechanisms, providing haptic input to those mechanisms, or interacting with those input mechanisms in other ways.

Object intelligence sensors 132 may include sensors such as image capture sensors (e.g., mono or stereo cameras, etc.), RADAR or LIDAR sensors, ultrasonic sensors, mechanical sensors or impact sensors, or any of a wide variety of other sensors that generate a sensor signal indicative of a characteristic of an object sensed by the sensors. For instance, the characteristics of the objects may indicate a direction and distance from work machine 102 that the object is sensed, the size of the object, the nature of the object (such as whether the object is a human being, another machine, or another object such as a rock or tree), or any of a wide variety of other characteristics of the sensed object. Once an object is identified by one or more other sensors, actions can be performed such as to automatically aim microphones or speakers in the direction of the object. The microphones or other sensors 112 may be configured to sense sounds or other things from engine 214, transmission 216, ground-engaging elements 218, or other elements of the propulsion subsystem 196. The sensors 112 can also be configured to detect sound from working or digging subsystems 194 or any of a wide variety of other actuators, subsystems, mechanical elements, etc., on work machine 102.

Sound management system 114 identifies sound components in the sound sensed by sensors 112 and generates control signals corresponding to those sound components, indicating whether the sound components should be cancelled or suppressed, amplified, reduced, or whether other sound components should be inserted into the audio received by operator 104 (such as alert signals, alarms, etc.). It will be noted that, while sound management system 114 is shown deployed completely on work machine 102, that is by way of example only. Sound management system 114 can just as easily be deployed in a remote server environment, on a different machine, on a different computing system, or distributed among one or more different locations or computing systems. For purposes of the present description, however, it will be assumed that sound management system 114 is deployed on work machine 102.

Sound management configuration UEX control system 136, as discussed above, controls operator interface subsystem 192 to conduct a user experience for an operator 104 that allows operator 104 to set or configure sound management configuration criteria 120.

Sound management identification system 138 identifies different components in the sound that is sensed by sensors 112. Sound component identification system 138 can also sense other characteristics or items sensed by sensors 112 and process those items as well.

Model running system 146 downloads and runs sound detection models 122 where those models are used to detect certain components of sound sensed by microphones 126, directional microphones 128, object intelligence sensors 132, etc. Thus, for example, a microphone 126 may be located on work machine 102 to preferentially capture sound generated by bearings, the engine, or another portion of work machine 102. That sound signal can be sent to a particular artificial intelligence or machine learning model 122 that is trained to identify problems identified by the sensed sounds. A microphone 126 or directional microphone 128 may be deployed on work machine 102 to capture sounds outside of the operator compartment and sound detection models 122 maybe trained to detect certain components of that captured sound (such as a human voice, a collision, the operation of another vehicle, etc.). Thus, model running system 146 can run the models 122 based on the inputs from sensors 112 and generate an output indicative of the different components sensed in the captured sound.

Human voice identifier 148 may be trained to specifically identify a human voice in the sound sensed by one or more of the sensors 112. Direction processor 150 may process the signals generated by sensors 112 to identify the direction of the location of the source of the sound components captured by the various sensors 112. For instance, direction processor 150 may receive an input from two different directional microphones 128 as well as a microphone 126 mounted to sense engine noise. Direction processor 150 may separate those signals and provide them to other items in sound component identification system 138 to identify components in the different sensor signals and to assign a direction or source location corresponding to each of those identified components. By way of example, direction processor 150 may isolate the different signals generated by directional microphones 128 and provide them to human voice identifier 148 which may identify a human voice in one of the signals. Direction processor 150 can then associate that detected human voice with a direction based upon the particular directional microphone 128 that generated the sound signal. One or more directional microphones 128 or speakers or other devices can then be pointed or aimed in the direction of the human voice.

Machine noise identifier 154 can be a model or other item that identifies different machine noises in the sound from the environment of work machine 102. Thus, machine noise identifier 154 may identify noises corresponding to the tracks, the engine, other machine noises, noises captured outside of the machine or from other sources, etc.

Acoustic characteristic identifier 156 may identify acoustic characteristics or acoustic signatures corresponding to different components in the sound signals generated by sensors 112. Acoustic characteristic identifier 156 may, for instance, capture a feature vector of acoustic features in the sound signal and process those features to determine whether an acoustic signature is present that is recognizable by acoustic characteristic identifier 156 or any of the other items in sound component identification system 138. Other acoustic characteristics may include amplitude, frequency, pattern, or other acoustic characteristics.

Sound source identifier 158 may identify the source of a sound, based upon which particular microphone or sensor 112 generated the sound signal from which the component was identified, or based on other criteria. Other sensor processing system 160 can process other sensors, such as the output from object intelligence sensors 132 or other sensors. The processed output can be correlated to the sound components identified in the signals generated by other sensors 112. For instance, the object intelligence sensors 132 may generate an output indicating that a human being is located at a certain distance, and in a certain direction, from work machine 102. This information may be provided to human voice identifier 148 which uses the information to aim directional microphones 128 and process the outputs of directional microphones 128 and to specifically look for the presence of a human voice in the sound signal generated by a directional microphone 128 that is pointed in the direction of the human being identified by object intelligence sensors 132. In another example, object intelligence sensors 132 may be a thermal sensor located adjacent a bearing and generate a sensor signal identifying that a portion of a bearing is at an elevated temperature relative to a normal temperature. This may be correlated to a sound captured by a microphone that is positioned to capture bearing sounds. The fusion of the sensors may indicate that the bearing is in need of maintenance. These are just some examples of how the output of object intelligence sensors 132 can be correlated to sound components identified by other items in sound component identification system 138.

Operator attention processor 152 may receive an input from operator attention sensors 130 and identify characteristics of the operator's attention based upon that input. For instance, operator attention processors 152 may provide an output indicating that the operator 104 is looking in a certain direction, or has his or her attention on a particular item on the instrument panel, on a particular operator input mechanism (such as a joystick, etc.). The output of operator attention processor 152 can be used by other items in sound component identification system to perform processing. For instance, if operator attention processor 152 generates an output indicating that operator 104 is looking outside the operator compartment of machine 102 in a particular direction, this may be used to preferentially process the sound signal generated by a directional microphone 128 that is aimed in that direction by processing that signal first, by amplifying that signal, etc. The operator attention also may be used in conjunction with object intelligence sensors 132. For instance, if operator attention processor 152 generates an output indicating that operator is looking in a certain direction, and if object intelligence sensors 132 indicate that a human being is also detected in that direction, then the sound signal generated by a directional microphone 128 that is also aimed in the same direction may be preferentially processed, amplified, etc. As an example, if the human voice identifier 148 identifies that the directional microphone 128 is picking up a human voice, then other noise components can be cancelled, but the human voice can be amplified and transmitted to operator 104 using speakers/earpieces/headphones 200. These and other sensor fusion techniques can be used to manage sound from work machine 102 that is presented to operator 104.

Component processing system 140 receives the outputs from sound component identification system 138 identifying the different components in the sensed sound. Component processing system 140 then generates an output to control signal generator 142 directing control signal generator 142 to generate control signals to perform a sound management action to manage the sound that is provided to operator 104 through speakers/earpieces/headphones 200. For instance, sound management configuration processor 164 can retrieve the sound management configuration criteria 120 corresponding to operator 104, or other default criteria, or other pre-defined criteria. Those criteria can be used by sound component action identification system 168 to determine what sound management actions to take based upon the particular sound components that have been identified in the sound signals generated by sensors 112. For instance, based upon the sound management criteria, cancellation component 172 may determine that certain sound components are to be cancelled (such as using noise cancellation, phase reversal, etc.). Reduction component 174 may, based on the sound management criteria, identify components of the sound that should be passed to operator 104 but that should first be quieted or reduced in volume. Amplification component 176 may identify sound components which should be amplified and provided to operator 104, and insertion component 178 may identify sound components that trigger the insertion of other sound components (such as that trigger the insertion of an alert or other alarm message). Active sound cancellation/subtraction/amplification/injection processor 166 then determines the amount by which the sound should be managed according to the sound management action and provides an output to control signal generator 142. Control signal generator 142 then generates a cancellation signal 182 to cancel sound components that are to be cancelled. Control signal generator 142 generates an amplification signal 184 to amplify sound components that are to be amplified. Control signal generator 142 generates reduction signal 186 to reduce or suppress or quiet certain sound components that are to be reduced or suppressed or quieted, and control signal generator 142 generates insertion signal 188 to insert a sound component into the sound provided to operator 104 (such as an alarm or alert message, etc.). Control signal generator 142 can generate other control signals 190 to perform other control operations, such as to control actuators to aim microphones or speakers, or to perform other operations as well.

Speakers/earpieces/headphones 200 may be worn by operator 104 or may be speakers in the head rest of a seat occupied by operator 104 or may be speakers or other mechanisms located elsewhere in the operating compartment of work machine 102.

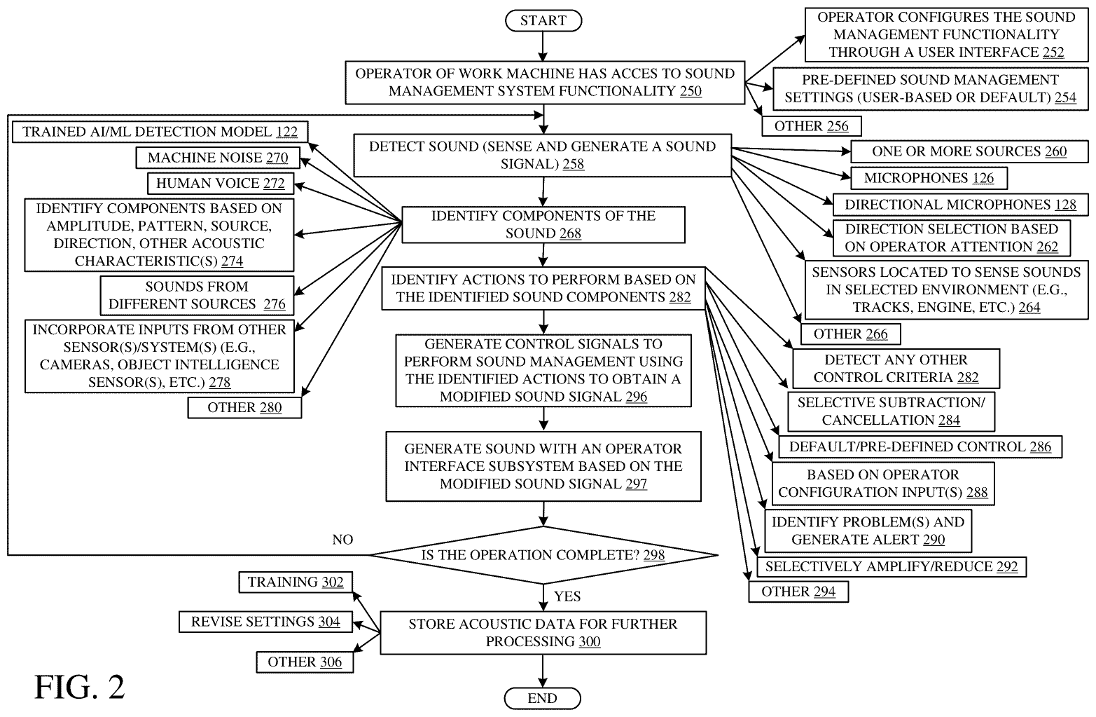

FIG. 2 is a flow diagram illustrating one example of the operation of sound management system 114 and work machine 102. It will first be assumed that operator 104 of work machine 102 has access to sound management system functionality, such as speakers/earpieces/headphones 200 and/or sound management system 114, as indicated by block 250 in the flow diagram of FIG. 2. In one example, operator 104 may configure the sound management functionality by setting sound management configuration criteria 120 through a user experience conducted by operator interface subsystem 192. Having operator 104 configure the sound management configuration criteria is indicated by block 252 in the flow diagram of FIG. 2. In another example, the configuration and sound management system 114 can determining which sound components to identify and cancel/amplify/reduce or insert using default sound management settings or criteria, or other pre-defined settings or criteria, as indicated by block 254 in the flow diagram of FIG. 2. The operator 104 of work machine 102 can have access to other management system functionality in other ways as well, as indicated by block 256.

During operation, sensors 112 detect sound as indicated by block 258 in the flow diagram of FIG. 2. The sound can be detected from one or more different sources 260. The sound from the different sources can be detected by microphones 126, directional microphones 128, or other sensors. The direction from which sound is detected and processed may be selected based upon operator attention, as sensed using operator attention sensors 130, and as indicated by block 262 in the flow diagram of FIG. 2. The microphones 126 or other sensors may be configured to sense sounds in selected environments, such as to sense sounds from the tracks 218, engine 214, etc., as indicated by block 264. Other sounds can be detected, and the sounds can be detected in other ways, as indicated by block 266.

Sound component identification system 138 then identifies one or more different components of the sound, as indicated by block 268 in the flow diagram of FIG. 2. In one example, trained artificial intelligence and/or machine learning detection models 122 can be used to detect different sound components. The models can be incorporated in or used by other items in sound component identification system 138, and run by model running system 146 or in other ways.

Machine noise identifier 154 can identify machine noise components of the sound 270, and human voice identifier 148 can identify human voice components of the sound as indicated by block 272. Acoustic characteristic identifier 156 can identify acoustic characteristics of the sound signals and identify components of the sound based upon the acoustic characteristics, such as amplitude, frequency, pattern, source, direction, or other characteristics, as indicated by block 174 in the flow diagram of FIG. 2. Sound source identifier 158 can detect sounds from different sources (such as from different microphones, different directional microphones, humans, different parts of the machine, etc.). Detecting sound components from different sources is indicated by block 276 in the flow diagram of FIG. 2. Other sensor processing system 160 can incorporate and process inputs from other sensors 112, such as cameras, object intelligence sensors 132, or other sensors as indicated by block 278 in the flow diagram of FIG. 2. A wide variety of other components of the sound can be detected in a wide variety of other ways as well, as indicated by block 280.

Once sound component identification system 138 has identified the components of the sound signals, sound component action identification system 168 identifies actions to perform based upon the identified sound components, as indicated by block 282 in the flow diagram of FIG. 2. For instance, one action could be to perform selective subtraction or noise cancellation as indicated by block 284. Another action may be a default or pre-defined action 286. The actions may be based on the operator configuration inputs as indicated by block 288. The actions can include inserting an alert or other sound delivered to operator 104, as indicated by block 290. The actions can include selective amplification or reduction as indicated by block 292. Other actions can be identified such as to aim microphones or speakers, or actions can be identified in a wide variety of other ways as well, as indicated by block 294.

Once the actions are identified, active sound cancellation/subtraction/amplification/injection processor 166 generates a signal indicative of the identified actions and provides the signal to control signal generator 142 which generates control signals to perform sound management using the identified actions, as indicated by block 296. Again, the actions can be to control the speakers/earpieces/headphones 200 to perform noise cancellation, amplification, noise reduction, sound insertion, or other actions. The actions can also include generating displays or alerts or other messages using user experience system 202 or other operator interface mechanisms 212, or aiming speakers or microphones.

Until the operation being performed by work machine 102 is completed, as determined at block 298 in the flow diagram of FIG. 2, processing reverts to block 258 where the sensors 112 continue to detect sound, the sound components are identified, etc. Once the operation is complete, as determined at block 298, then the acoustic data can be stored for further processing, as indicated by block 300. The acoustic data, identified sound components, actions, and control signals can all be stored for future training 302, to revise sound management configuration settings as indicated by block 304, or for any of a wide variety of other reasons, as indicated by block 306.

It can thus be seen that the present description describes a system which identifies sound components in an environment around a work machine and performs sound management to manage those sound components. The sound management may be performed based upon default or predefined criteria, or the sound management can be based on user-specific criteria that are entered by an operator or otherwise.

The present discussion has mentioned processors and servers. In one example, the processors and servers include computer processors with associated memory and timing circuitry, not separately shown. The processors and servers are functional parts of the systems or devices to which the processors and servers belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, identifiers, and/or logic. It will be appreciated that such systems, components, identifiers, and/or logic can be comprised of hardware items (such as processors and associated memory, or other processing components, some of which are described below) that perform the functions associated with those systems, components, identifiers, and/or logic. In addition, the systems, components, identifiers, and/or logic can be comprised of software that is loaded into a memory and is subsequently executed by a processor or server, or other computing component, as described below. The systems, components, identifiers, and/or logic can also be comprised of different combinations of hardware, software, firmware, etc., some examples of which are described below. These are only some examples of different structures that can be used to form the systems, components, identifiers, and/or logic described above. Other structures can be used as well.

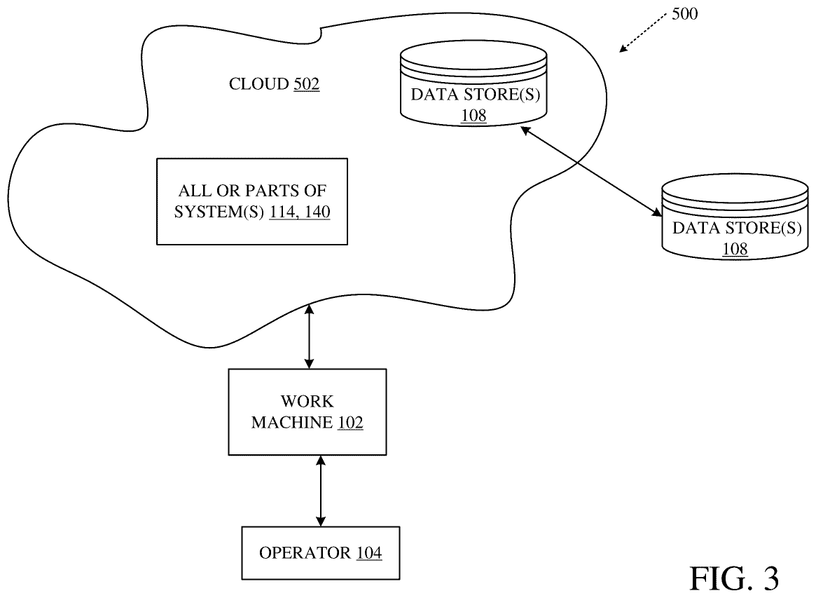

FIG. 3 is a block diagram of work machine 102, shown in FIG. 1, except that it communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or the components and functions can be installed on client devices directly, or in other ways.

In the example shown in FIG. 3, some items are similar to those shown in previous FIGS. and they are similarly numbered. FIG. 3 specifically shows that systems 136, 138, 140, and/or data store 108 can be located at a remote server location 502. Therefore, work machine 102 accesses those systems through remote server location 502.

FIG. 3 also depicts another example of a remote server architecture. FIG. 3 shows that it is also contemplated that some elements of previous FIGS are disposed at remote server location 502 while others are not. By way of example, data store 108 or other systems can be disposed at a location separate from location 502, and accessed through the remote server at location 502. Regardless of where the items are located, the items can be accessed directly by work machine 102, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

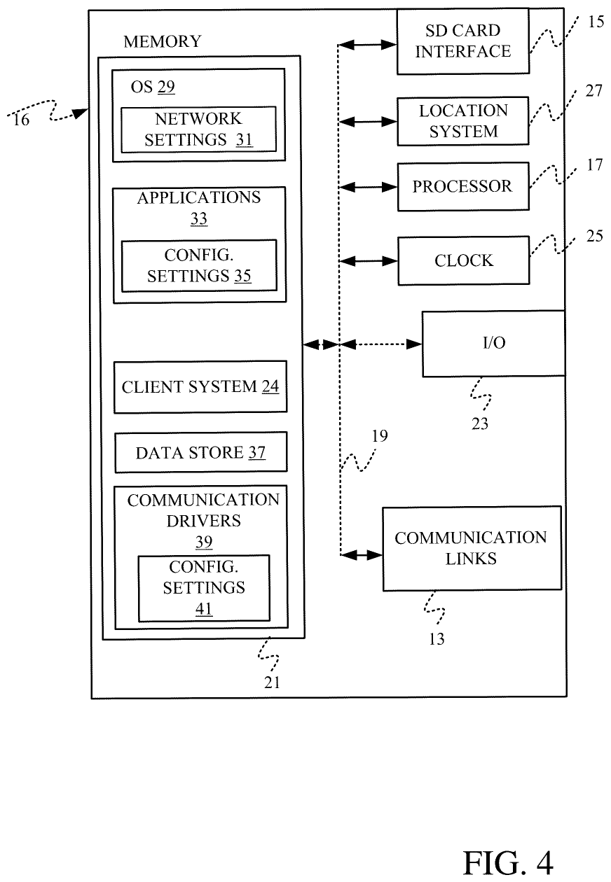

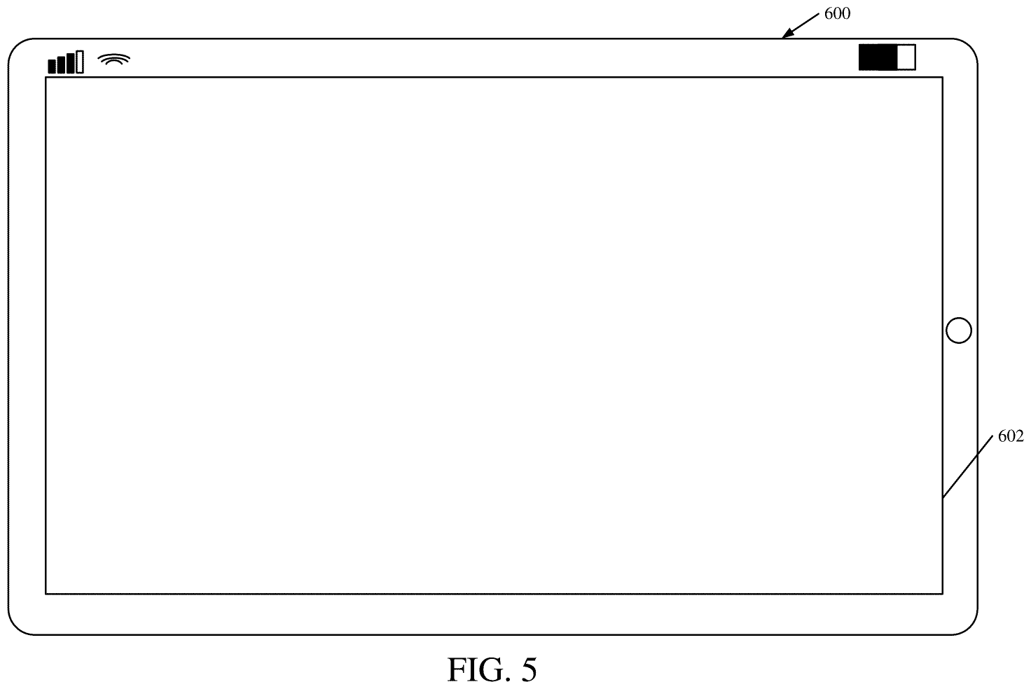

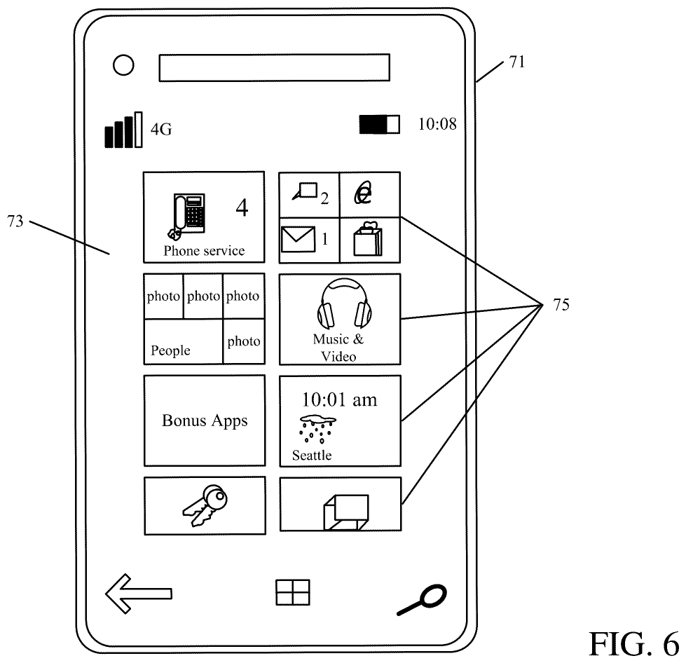

FIG. 4 is a simplified block diagram of one illustrative example of a handheld or mobile computing device that can be used as a user's or client's hand held device 16, in which the present system (or parts of it) can be deployed. For instance, a mobile device can be deployed in the operator compartment of work machine 102 for use in generating and conducting the UEX for operator 104. FIGS. 5-6 are examples of handheld or mobile devices.

FIG. 4 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according 13 to the instructions. Processor 17 can be activated by other components to facilitate their functionality as well.

FIG. 5 shows one example in which device 16 is a tablet computer 600. In FIG. 5, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 6 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

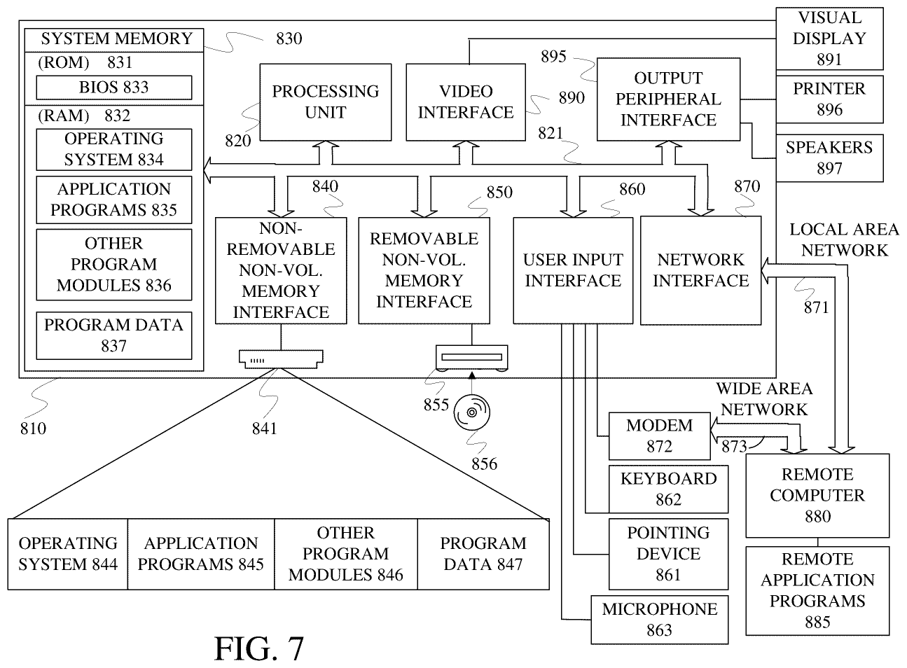

FIG. 7 is one example of a computing environment in which elements of previous FIGS., or parts of it, (for example) can be deployed. With reference to FIG. 7, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 7 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
sensing sound on a work machine;
generating a sound signal based on the sensed sound;
identifying a component of the sound in the sound signal;
performing a sound management action based on the identified component to obtain a modified sound signal; and
generating sound with an operator interface subsystem based on the modified sound signal.

2. The computer implemented method of claim 1 wherein performing a sound management action comprises:
identifying the sound management action based on the identified component; and
generating a control signal to execute the sound management action.

3. The computer implemented method of claim 1 wherein identifying the sound component comprises:
identifying, as the sound component, machine sound generated by the work machine, wherein performing the sound management action comprises performing sound reduction to reduce the machine sound in the sound signal to obtain the modified sound signal.

4. The computer implemented method of claim 3 wherein performing sound reduction comprises performing sound cancellation to remove the machine sound from the sound signal.

5. The computer implemented method of claim 1 wherein identifying the sound component comprises:
identifying as the sound component a sound indicative of a characteristic of the work machine, wherein performing the sound management action comprises inserting an alert in the sound signal based on the characteristic of the machine to obtain the modified sound signal.

6. The computer implemented method of claim 1 wherein identifying the sound component comprises:
identifying as the sound component a desirable sound component that is to be provided to the operator interface subsystem, wherein performing the sound management action comprises amplifying the desirable sound component in the sound signal to obtain the modified sound signal.

7. The computer implemented method of claim 6 wherein identifying the sound component comprises:
identifying as the desirable sound component a human voice, wherein performing the sound management action comprises amplifying the human voice in the sound signal to obtain the modified sound signal.

8. The computer implemented method of claim 1 wherein identifying a sound component comprises:
detecting a direction, relative to the work machine, from which the sound is received; and
identifying the sound component based on the direction.

9. The computer implemented method of claim 1 wherein identifying a sound component comprises:
sensing an operator attention characteristic indicative of an attribute of operator attention;
generating an operator attention signal based on the operator attention characteristic; and
identifying the sound component based on the operator attention signal.

10. The computer implemented method of claim 1 wherein identifying a sound component comprises:
sensing, with an object sensor on the work machine, an object characteristic indicative of a characteristic of the object;
generating an object characteristic signal based on the object characteristic; and
identifying the sound component based on the object characteristic signal.

11. The computer implemented method of claim 10 wherein identifying the sound component comprises:
aiming a microphone based on the object characteristic signal

12. The computer implemented method of claim 1 wherein identifying a sound component comprises:
identifying acoustic features of the sound signal; and
running a machine learning model based on the acoustic characteristics to identify the sound component.

13. The computer implemented method of claim 1 and further comprising:
generating an operator interface with a sound management configuration input mechanism; and
detecting an operator actuation of the sound management configuration input mechanism to identify a sound management configuration criterion, wherein identifying the component comprises identifying the component based on the sound management configuration criterion, and wherein performing a sound management action comprises identifying the sound management action based on the sound management configuration criterion.

14. A work machine, comprising:
a sound sensor on the work machine configured to sense sound and generate a sound signal based on the sensed sound;
a sound component identification system configured to identify a component of the sound in the sound signal;
a component processing system configured to identify a sound management action based on the identified component; and
a control signal generator configured to generate a control signal to perform the sound management action to obtain a modified sound signal and to control an operator interface subsystem to generate sound based on the modified sound signal.

15. The work machine of claim 14 wherein the sound component identification system comprises:
a machine noise identifier configured to identify, as the sound component, machine sound generated by the work machine, wherein the component processing system comprises an active noise cancellation processor configured to perform sound reduction to reduce the machine sound in the sound signal to obtain the modified sound signal.

16. The work machine of claim 14 wherein the sound component identification system comprises:
an acoustic characteristic identifier configured to identify a sound indicative of an alert condition of the work machine, wherein the component processing system comprises a sound insertion component configured to insert an alert sound into the sound signal to obtain the modified sound signal.

17. The work machine of claim 14 wherein the component identification system comprises:
a human voice identifier configured to identify human voice that is to be provided to the operator interface subsystem, wherein the component processing system comprises an amplification component configured to amplify the human voice in the sound signal to obtain the modified sound signal.

18. The work machine of claim 14 wherein the sound sensor comprises:
a directional microphone that senses sound in a direction and generates a directional microphone signal, wherein the sound component identification system comprises a direction processor configured to detect the direction, relative to the work machine, from which the sound is received based on the directional microphone signal and wherein the sound component identification system is configured to identify the sound component based on the direction.

19. The work machine of claim 14 and further comprising:
an object sensor configured to sense an object characteristic indicative of a characteristic of the object and generate an object characteristic signal based on the object characteristic and wherein the sound component identification system is configured to identify the sound component based on the object characteristic signal.

20. A control system, comprising:
a sound sensor on the work machine configured to sense sound and generate a sound signal based on the sensed sound;
a sound component identification system configured to identify a component of the sound in the sound signal; and
a control signal generator configured to generate a control signal to perform a sound management action based on the identified component of the sound.
